(19) United States
(12) Patent Application Publication
(10) Pub. No.: US 2021/0243301 A1
(43) Pub. Date: Aug. 5, 2021

(54) ADDRESS RELIABILITY AND AUGMENTATION FOR EMERGENCY TEXT

(71) Applicant: Microsoft Technology Licensing, LLC, Redmond, WA (US)

(72) Inventors: Frank Bruce Shearar, Sammamish, WA (US); Amer Aref Hassan, Kirkland, WA (US); David Anthony Lickorish, Sammamish, WA (US)

(21) Appl. No.: 16/780,576

(22) Filed: Feb. 3, 2020

(51) Int. Cl. H04M 3/51; H04W 4/14; H04W 76/50; H04W 4/029; H04M 11/04; H04W 64/00; H04W 4/90

(52) U.S. Cl. CPC H04M 3/5116; H04W 4/14; H04W 76/50; H04W 4/029; H04M 2242/30; H04W 64/003; H04W 4/90; H04M 2242/04; H04M 11/04

(57) ABSTRACT

Systems and methods may be used for providing an emergency text service via a mobile device. These systems and methods may include receiving an indication that an emergency text service has been started at the mobile device, generating a user interface component for entry of a location by a user, and receiving, via the user interface component, location information entered by the user. The systems and methods may include separately determining a probable location of the mobile device without user input and sending, in a single emergency communication, both the location information entered by the user and the probable location of the mobile device.

### BACKGROUND

In traditional 911 or other emergency service calls, for example in the United States, a landline's location is automatically sent to a dispatcher receiving the call. In addition to landline emergency services; enhanced 911 (e.g., e911 or E112 in Europe) is available for aiding in location determination for an emergency call from a mobile device (e.g., a cell phone). Some jurisdictions now provide emergency service contacts via text message on a mobile device, often referred to as text-to-911. However, location data for a mobile device is sometimes unreliable, and obtaining precise or accurate location data may be difficult.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-3 illustrate an example mobile device for sending an address in an emergency text according to some examples of the present disclosure.

FIG. 4 illustrates an example emergency service display for providing address information according to some examples of the present disclosure.

FIG. 5 illustrates a diagram of a map illustrating location information according to some examples of the present disclosure.

FIG. 6 illustrates a flowchart of a technique for providing an emergency text service according to some examples of the present disclosure.

FIG. 7 illustrates a block diagram of an example machine which may implement one or more of the techniques discussed herein according to some examples of the present disclosure.

### DETAILED DESCRIPTION

Systems and methods for providing an emergency text service on a mobile device are described herein. These systems and methods may be used to provide address services to supplement a user-entered address, for example when there is uncertainty about a location of a mobile device. In an example, precise or accurate location data for a mobile device may not be available or accurate when the location is manually submitted by a user to an emergency text service. For example, a user may not know an exact location or address, may be mistaken (e.g., due to emergency circumstances), due to reliance on the user's memory or issues with clearly remembering or typing (or using voice-to-text) during an emergency, or the like. Some jurisdictions require or rely on a user to enter location information when sending a text to request emergency services or report an emergency.

The systems and methods described herein solve the technical issues involved with inaccuracy and unreliability of manual user entered or selected addresses, while also avoiding the potential inaccuracies of an entirely automated location determination. The systems and methods described herein solve these technical issues by providing automatically determined location or address information along with user entered or selected location or address information, for example together in a single message (e.g., a text message to an emergency text service). The message may have a specific format, for example including the user selected or entered location or address in the body of the message and the automatically determined location or address in metadata of the message. In another example, both locations or addresses may be sent in a body of a message. The addresses may have indications of origin (e.g., user or automatically determined), probabilities of accuracy, or confirmation of agreement or alert about discrepancy between the addresses.

These solutions may have the added benefit of complying with jurisdictional requirements that addresses not be automatically sent to emergency services without also providing a user address. In an example, the automatic address or location sending may be included as an opt-in feature.

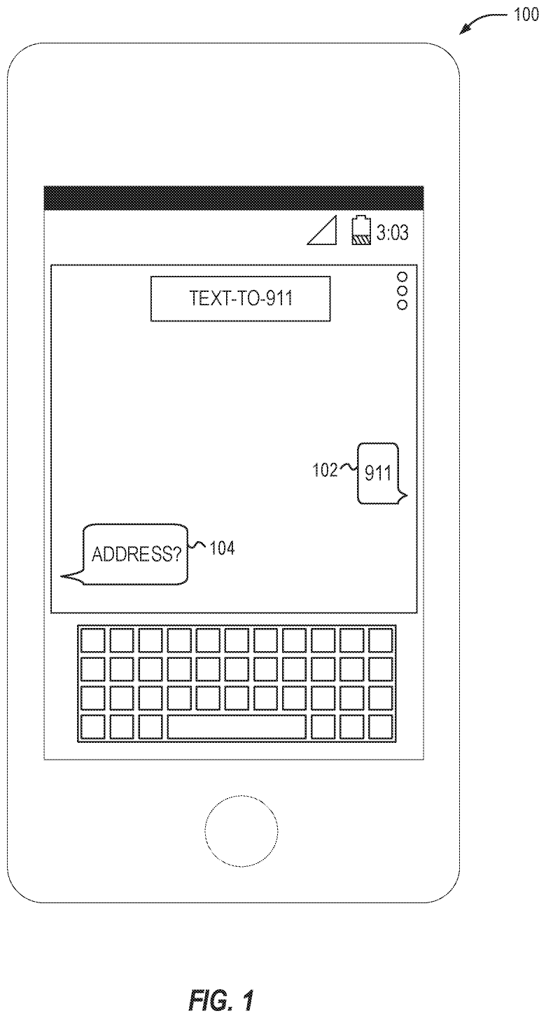

FIG. 1 illustrates an example mobile device 100 for sending an address in an emergency text according to some examples of the present disclosure. The mobile device may include memory, a display, and one or more hardware processors.

The mobile device 100 includes an example emergency text that has been initiated. A message 102 may be sent to indicate that an emergency text has started. A response 104 may be sent from a dispatcher or automated emergency service asking for additional details (e.g., an address or location of the mobile device). The message 102 and response 104 are examples shown for ease of understanding the techniques described herein, but other indications of initiation of an emergency text or communications may be used. For example, entering the emergency text message number may be an indication that a message has been started.

A user may be presented with a selectable address or location or a set of addresses or locations to select from, or the user may enter an address or location via a keyboard. For example, a selectable address may include an address generated from previously user entered addresses. An address may include a partially entered address by a user that is completed using location data (e.g., from a map database or app). For example, if the user has entered 101 First Ave, a compass direction, a city, a state, or a zip code may be added based on location data.

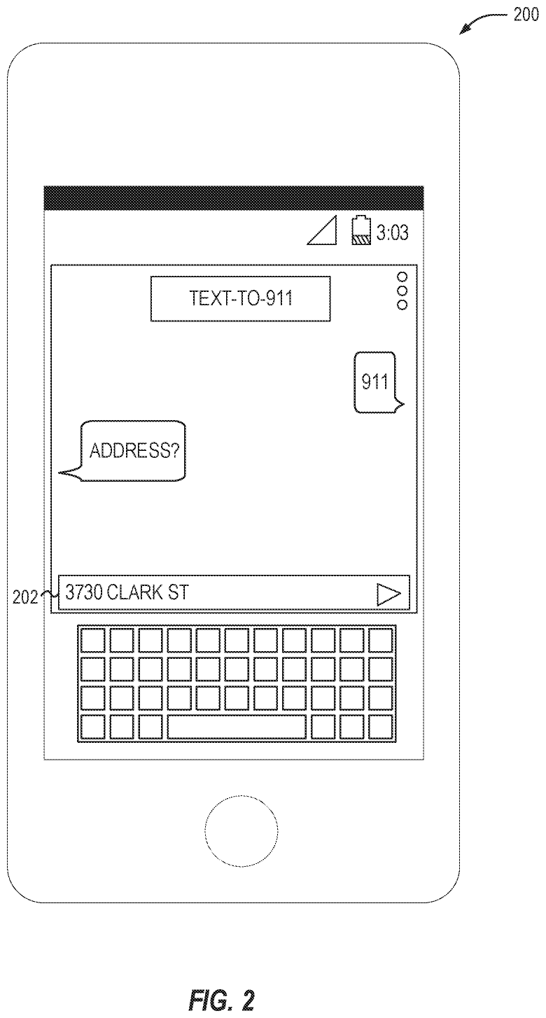

FIG. 2 shows an example with the mobile device 200 having a selected or entered address in an editable field 202. From there, the user may further edit the address or may send the address. Selectable addresses may include addresses obtained based on a user's preselected addresses. These addresses may be stored specifically for the purpose of using them in an emergency services message or may be stored more generally (e.g., a home address, a work address, etc.). The mobile device 200 may identify the request for an address (e.g., 104 of FIG. 1), for example using natural language processing or using a preprogrammed cue for the emergency service. In response to identifying the address request, the mobile device 200 may present selectable addresses, in an example. The mobile device 200 may, in response to identifying the address request, automatically determine an address or location of the mobile device, for example to supplement the user entered or selected address.

In an example, a selectable address may be derived from a saved place or an often-frequented place, such as based on data from a map app or location services of the mobile device. For example, the user may keep a home or work address in a map app. In an example, the address of the mobile device may be inferred from map app data. For example, when the mobile device has two or more probable locations, one may be selected based on user data, such as a to be visited or starred address on a map app, a home or work address, an address stored in a contact list, an address associated with a calendar appointment for a current time, or the like.

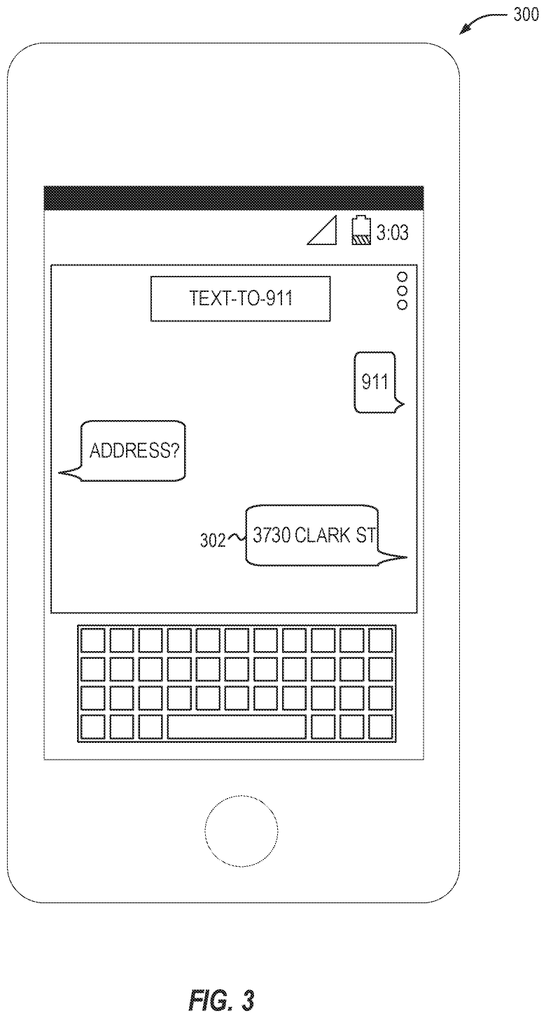

FIG. 3 shows an example with a mobile device 300 having a selected or entered address sent in a message 302 to an emergency service. The message 302 includes a user entered or selected address or location, which may be visible to the user in the text stream on the mobile device 300. The message 302 may include additional location information. The additional location information may be visible in the text stream to the user or may be hidden (e.g., in metadata). The additional location information may be visible in a text stream displayed at an emergency service device as received. The additional location information may be sent in the message 302 with the user entered or selected address or location as a single message.

The additional location information may include an automatically determined address or location of the mobile device. The address or location may be automatically determined, for example, at the time the message 302 is sent, or in response to initiation of the emergency text. In an example, the address or location of the mobile device may be determined from automatic location data of the mobile device (e.g., GPS, an address of a device connected to the mobile device including an access point (AP) or an Evolved Terrestrial Radio Access Network (E-UTRAN) node B (eNodeB), RFID, other mobile devices nearby, geofencing information, NEC, or the like), or from a combination thereof.

In an example, the address or location may be generated from location data received at the mobile device. The location data may be generated from communication with a device having a known location (e.g., a static device) or a device having a likely address (e.g., another mobile device, which may be used to compare to the mobile device's own location data, for example from GPS, to verify, for example when both mobile devices have matching addresses, the likelihood of that probable location increases). Example devices that the mobile device may communicate with to determine a location include an access point (e.g., a WiFi access point), an eNodeB or other base station for communicating over a wireless network, a GPS satellite, a geofence, an RFID or NFC device, a Bluetooth device, a desktop computer, a smart device (e.g., a thermostat, refrigerator, home security system, etc.), a printer, or the like. The automatically determined address or location information may be appended or added to the message 302 when sent to the emergency service.

In some examples, the message 302 may be sent from the mobile device 300 without the automatically determined address or location. In these examples, the automatically determined address or location may be added by another device (e.g., along a communication pathway) before the message 302 arrives at the emergency service. For example, a WiFi-access point, a relay mobile device, a cell tower, or the like may add an automatically determined address or location (e.g., determined by the other device or by the mobile device, but sent separately to the other device) to the message 302 before the message is then sent on to the emergency service.

In an example, the mobile device may verify whether location data for the mobile device corresponds (or is in range/proximity) to the address sent in the message 302. When the address corresponds, the mobile device may include a confirmation in the message 302 for use by the emergency service. When the address entered or selected by the user is suspected to be incorrect (e.g., is outside a range or proximity of the automatically determined address or location data) the mobile device may include an alert or warning in the message 302 for use by the emergency service.

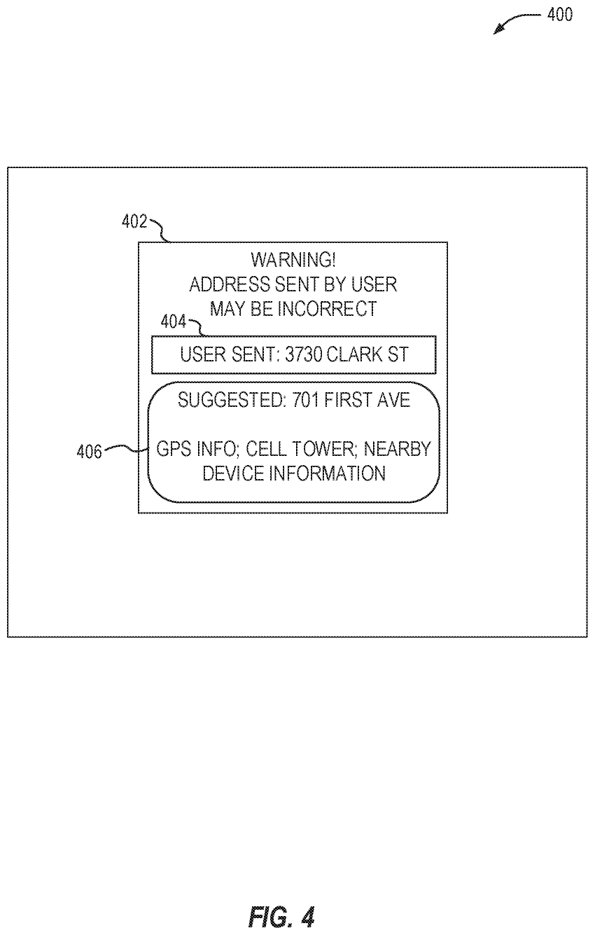

FIG. 4 illustrates an example display 400 including a warning on a user interface component. The alert or warning 402 may indicate with words or symbols that the address sent by the user was likely incorrect. The alert or warning 402 may include information regarding the user selected or entered address 404, or an automatically determined location or address 406. The automatically determined location or address 406 may include information about how the automatically determined location or address was determined, such as via GPS, a cell tower identifier, nearby device information, or the like.

In an example, a confidence level may be displayed (e.g., 90% likelihood that the automatically determined location or address is correct or 20% likelihood that neither the user entered or selected or the automatically determined location or address is correct).

The emergency dispatcher or user operating the emergency system display 400 may select an address or location from the user sent or the automatically determined one to send first responders. In another example, a first responder may be sent to both addresses or locations. In yet another example, devices in communication with the mobile device of the user that initiated the emergency communication may be pinged to determine accuracy of the addresses or locations.

In an example, the multiple addresses or locations may be determined automatically, such as according to a probability (e.g., 75% likelihood that the mobile device is at 102 First Ave, and 25% likelihood that the mobile device is at 104 First Ave). The multiple addresses or locations may be sent to the emergency service. A most likely address or location may be displayed on the display 400, or some or all of the multiple addresses or locations may be displayed. Likelihood information may be displayed with a respective address or location. The mobile device may repeatedly or continuously automatically determine location or address information, and an additional message with updated location or address information may be sent. The updated information may be shown on the display 400, for example by increasing a displayed likelihood of an address or location being correct, removing an unlikely address or location, highlighting or otherwise indicating confirmation of an address, or the like. In an example, a prompt may be displayed on the display 400 suggesting that the dispatcher or user of the emergency service ask the user (e.g., send a message to the mobile device) for confirmation of the address or location, or suggest a change to the automatically determined address or location. In an example, a text message may be automatically generated for sending to the mobile device on confirmation by the dispatcher or user of the emergency service.

In an example, the address or location may be automatically determined at the mobile device in a process opaque to the user. This may include determining the location or address without any user input, or after the user opts in. This example may further include determining and sending the address or location automatically without user input or knowledge. For example, the address or location may be sent in metadata of a message without indicating to the user of the mobile device that the address or location has been determined or sent.

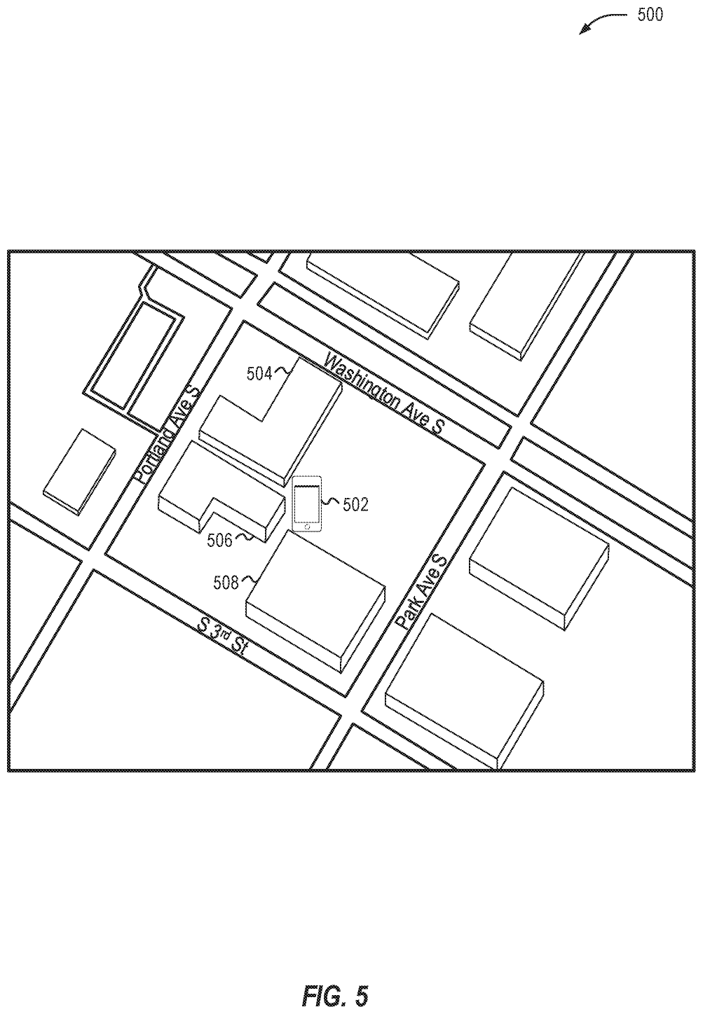

FIG. 5 illustrates a diagram of a map 500 illustrating location information according to some examples of the present disclosure. The map 500 shows a mobile device 502, along with a one or more likely locations (e.g., addresses) for example locations 504, 506, or 508. The map 500 is representative of various locations to show proximity and the potential for difficulty in determining an accurate address of the mobile device 502.

The location within the map 500 of the mobile device 502 may be determined using any of the techniques described herein (e.g., from an eNodeB, an access point, another device with a known location, a user entered address, GPS, etc.). The locations 504, 506, and 508 may, in an example, be automatically determined as a potential location of the mobile device 502. One of the locations 504, 506, and 508 may be selected as a most probable location of the mobile device 502 based on location data (e.g., a closest of the potential locations). probability may be output with the location selected (or with multiple locations selected). The probable location of the mobile device 502 may be based on user information, such as a user entered address corresponding to one of the locations 504, 506, and 508 (e.g., location 506 is the user's home or place of work), past user interaction data (e.g., location 508 is stored in the mobile device 502 as a place the user has visited in the past, saved in a map app, or the like), user intent (e.g., location 504 is marked to be visited), or based on user data (e.g., location 506 is a saved address in a contacts list).

In the example discussed above with respect to FIGS. 1-3, one or more of the locations 504, 506, and 508 may be sent in a message with a user selected or entered address. In another example, when the mobile device 502 verifies (before or after sending) that an address selected by a user corresponds to one of the locations 504, 506, and 508, a confirmation message may be generated, included in a message with the address, or sent automatically. The confirmation message may indicate that location data of the mobile device 502 confirms the user selected address.

In some examples, the map may be shown to a user and the user may be able to drag and drop the mobile device 502 to a selected location. The location the user dropped the mobile device 502 may be inserted into the message.

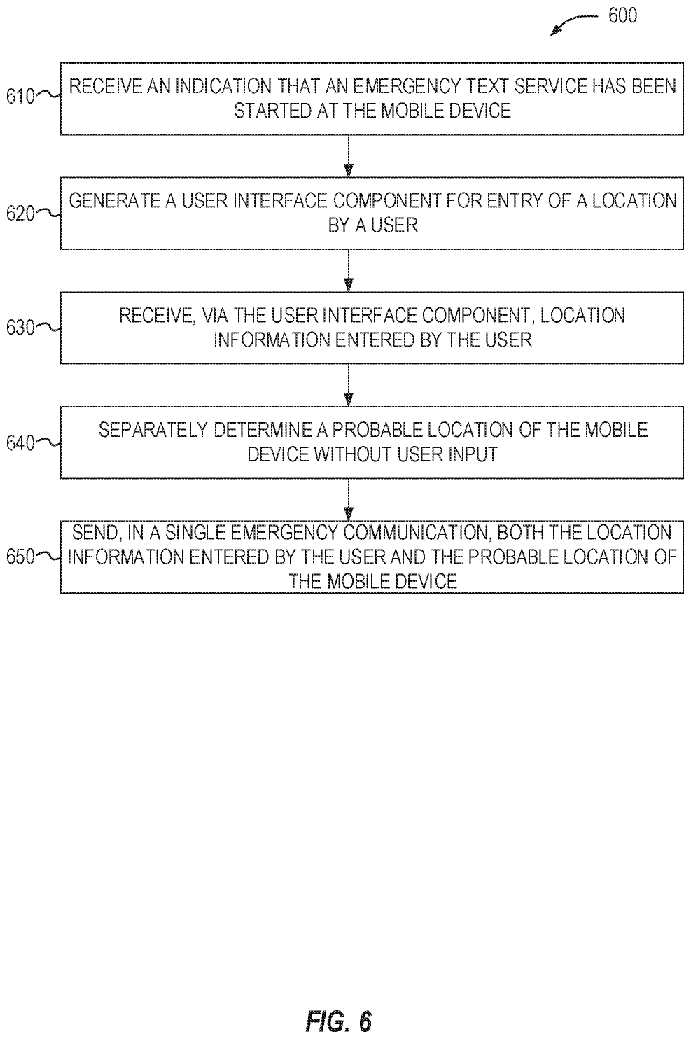

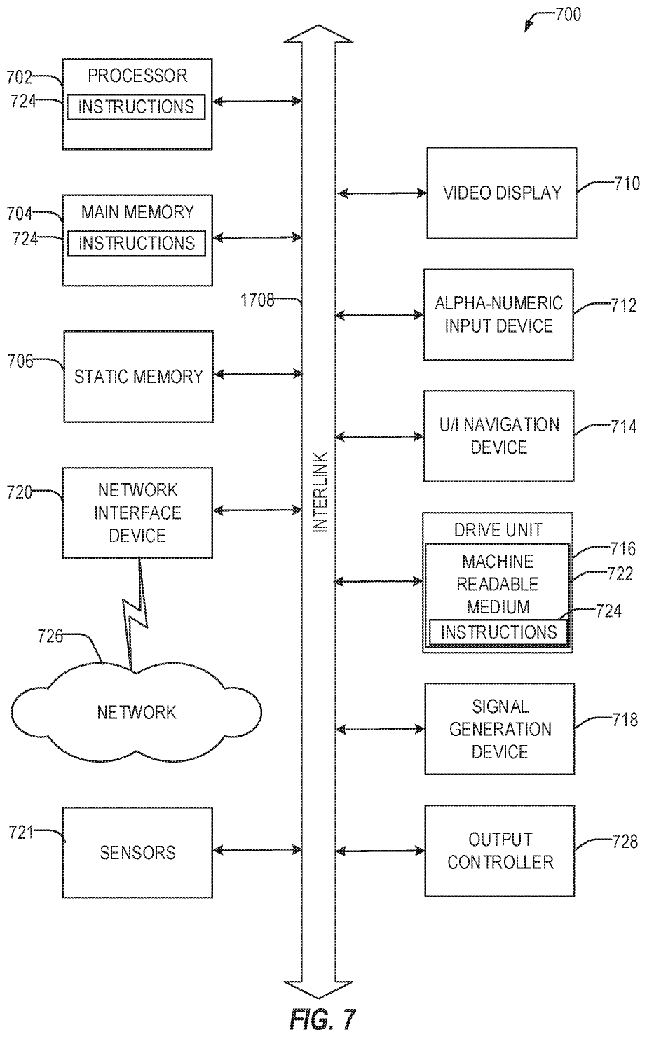

FIG. 6 illustrates a flowchart of a technique 600 for providing an emergency text service on a mobile device according to some examples of the present disclosure. The technique 600 may be performed using a processor or processors of the mobile device (e.g., as discussed in further detail below with respect to FIG. 7).

The technique 600 includes an operation 610 to receive an indication that an emergency text service has been started at the mobile device. The technique 600 includes an operation 620 to generate a user interface component for entry of a location by a user. The technique 600 includes an operation 630 to receive, via the user interface component, location information entered by the user. The technique 600 includes an operation 640 to separately determine a probable location of the mobile device without user input.

The technique 600 includes an operation 650 to send, in a single emergency communication, both the location information entered by the user and the probable location of the mobile device. Operation 650 may include sending the single emergency communication to an emergency service system. In an example, when the location information entered by the user corresponds to the probable location, sending an indication that the location information entered by the user is reliable in the single emergency communication (e.g., confirmation that the user entered location is likely correct or corroborated by the automatically determined location). In another example, when the location information entered by the user conflicts with the probable location, sending an indication that the location information entered by the user is unreliable. A probability may be sent about the reliability of the probable location. In an example, the probable location may be determined and sent using a background process opaque to the user. The single emergency communication may be a text message. In an example, the probable location is sent in metadata of the text message. The technique 600 may include, after sending the single emergency communication, determining an update in the probable location of the mobile device, and sending the updated probable location of the mobile device.

FIG. 7 illustrates a block diagram of an example machine 700 which may implement one or more of the techniques (e.g., methodologies) discussed herein according to some examples of the present disclosure. In alternative embodiments, the machine 700 may operate as a standalone device or may be connected (e.g., networked) to other machines. In a networked deployment, the machine 700 may operate in the capacity of a server machine, a client machine, or both in server-client network environments. The machine 700 may be configured to perform the methods of FIG. 6. The machine 700 may be configured to provide the GUIs of FIGS. 1-4. In an example, the machine 700 may act as a peer machine in peer-to-peer (P2P) (or other distributed) network environment. The machine 700 may be a user device, a remote device, a second remote device or other device which may take the form of a personal computer (PC), a tablet PC, a set-top box (SIB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NEC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may be non-transitory machine readable media. In some examples, machine readable media may include machine readable media that is not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SEM), multiple-input multiple-output (MIMO), or multiple-input single-output (MISO) techniques. In some examples, the network interface device 720 may wirelessly communicate using Multiple User MIMO techniques.

Example 1 is a method of providing an emergency text service on a mobile device, the method comprising: receiving an indication that an emergency text service has been started at the mobile device; generating, using at least one processor of the mobile device, a user interface component for entry of a location by, a user; receiving, via the user interface component, location information entered by the user; separately determining a probable location of the mobile device without user input; and sending, in a single emergency communication; both the location information entered by the user and the probable location of the mobile device.

In Example 2, the subject matter of Example 1 includes, wherein sending the single emergency communication includes sending the single emergency communication to an emergency service system.

In Example 3, the subject matter of Examples 1-2 includes, wherein sending the single emergency communication includes when the location information entered by the user corresponds to the probable location, sending in the single emergency communication an indication that the location information entered by the user is reliable.

In Example 4, the subject matter of Examples 1-3 includes, wherein sending the single emergency communication includes when the location information entered by the user conflicts with the probable location, sending in the single emergency communication an indication that the location information entered by the user is unreliable.

In Example 5, the subject matter of Examples 1-4 includes, wherein sending the single emergency communication includes sending a probability that the probable location is reliable.

In Example 6, the subject matter of Examples 1-5 includes, wherein the probable location is determined and sent using a background process opaque to the user.

In Example 7, the subject matter of Examples 1-6 includes, wherein the single emergency communication is a text message and wherein the probable location is sent in metadata of the text message.

In Example 8, the subject matter of Examples 1-7 includes, after sending the single emergency communication, determining an update in the probable location of the mobile device, and sending the updated probable location of the mobile device.

Example 9 is a mobile device for providing an emergency text service, the mobile device comprising: one or more hardware processors; a memory, storing instructions, which when executed, cause the one or more hardware processors to perform operations comprising: receiving an indication that an emergency text service has been started at the mobile device; generating a user interface component for entry of a location by a user; receiving, via the user interface component, location information entered by the user; separately determining a probable location of the mobile device without user input; and sending, in a single emergency communication, both the location information entered by the user and the probable location of the mobile device.

In Example 10, the subject matter of Example 9 includes, wherein sending the single emergency communication includes sending the single emergency communication to an emergency service system.

In Example 11, the subject matter of Examples 9-10 includes, wherein sending the single emergency communication includes when the location information entered by the user corresponds to the probable location, sending in the single emergency communication an indication that the location information entered by the user is reliable.

In Example 12, the subject matter of Examples 9-11 includes, wherein sending the single emergency communication includes when the location information entered by the user conflicts with the probable location, sending in the single emergency communication an indication that the location information entered by the user is unreliable.

In Example 13, the subject matter of Examples 9-12 includes, wherein sending the single emergency communication includes sending a probability that the probable location is reliable.

In Example 14, the subject matter of Examples 9-13 includes, wherein the probable location is determined and sent using a background process opaque to the user.

In Example 15, the subject matter of Examples 9-14 includes, wherein the single emergency communication is a text message and wherein the probable location is sent in metadata of the text message.

In Example 16, the subject matter of Examples 9-15 includes, wherein the one or more hardware processors are further configured to perform operations comprising, after sending the single emergency communication, determining an update in the probable location of the mobile device, and sending the updated probable location of the mobile device.

Example 17 is an apparatus for providing an emergency text service, the apparatus comprising: means for receiving an indication that an emergency text service has been started at the mobile device; means for generating a user interface component for entry of a location by a user; means for receiving, via the user interface component, location information entered by the user; means for separately determining a probable location of the mobile device without user input; and means for sending, in a single emergency communication, both the location information entered by the user and the probable location of the mobile device.

In Example 18, the subject matter of Example 17 includes, wherein the means for sending the single emergency communication include means for sending the single emergency communication to an emergency service system.

In Example 19, the subject matter of Examples 17-18 includes, wherein the means for sending the single emergency communication include, when the location information entered by the user corresponds to the probable location, means for sending in the single emergency communication an indication that the location information entered by the user is reliable.

In Example 20, the subject matter of Examples 17-19 includes, wherein the means for sending the single emergency communication include, when the location information entered by the user conflicts with the probable location, means for sending in the single emergency communication an indication that the location information entered by the user is unreliable.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

1. A method of providing an emergency text service on a mobile device, the method comprising:
receiving an indication that an emergency text service has been started at the mobile device;
generating, using at least one processor of the mobile device, a user interface component for entry of a location by a user;
receiving, via the user interface component, location information entered by the user;
separately determining a probable location of the mobile device without user input;
generating a single emergency communication message including the location information entered by the user and the probable location of the mobile device; and
sending the single emergency communication message, in a single emergency communication from the mobile device, including both the location information entered by the user and the probable location of the mobile device.

2. The method of claim 1, wherein sending the single emergency communication includes sending the single emergency communication to an emergency service system.

3. The method of claim 1, wherein sending the single emergency communication includes when the location information entered by the user corresponds to the probable location, sending in the single emergency communication an indication that the location information entered by the user is reliable.

4. The method of claim 1, wherein sending the single emergency communication includes when the location information entered by the user conflicts with the probable location, sending in the single emergency communication an indication that the location information entered by the user is unreliable.

5. The method of claim 1, wherein sending the single emergency communication includes sending a probability that the probable location is reliable.

6. The method of claim 1, wherein the probable location is determined and sent using a background process opaque to the user.

7. The method of claim 1, wherein the single emergency communication is a text message and wherein the probable location is sent in metadata of the text message.

8. The method of claim 1, further comprising after sending the single emergency communication, determining an update in the probable location of the mobile device, and sending the updated probable location of the mobile device.

9. A mobile device for providing an emergency text service, the mobile device comprising:
one or more hardware processors;
a memory, storing instructions, which when executed, cause the one or more hardware processors to perform operations comprising:
receiving an indication that an emergency text service has been started at the mobile device;
generating a user interface component for entry of a location by a user;
receiving, via the user interface component, location information entered by the user;
separately determining a probable location of the mobile device without user input;
generating a single emergency communication message including the location information entered by the user and the probable location of the mobile device; and
sending the single emergency communication message, in a single emergency communication from the mobile device, including both the location information entered by the user and the probable location of the mobile device.

10. The mobile device of claim 9, wherein sending the single emergency communication includes sending the single emergency communication to an emergency service system.

11. The mobile device of claim 9, wherein sending the single emergency communication includes when the location information entered by the user corresponds to the probable location, sending in the single emergency communication an indication that the location information entered by the user is reliable.

12. The mobile device of claim 9, wherein sending the single emergency communication includes when the location information entered by the user conflicts with the probable location, sending in the single emergency communication an indication that the location information entered by the user is unreliable.

13. The mobile device of claim 9, wherein sending the single emergency communication includes sending a probability that the probable location is reliable.

14. The mobile device of claim 9, wherein the probable location is determined and sent using a background process opaque to the user.

15. The mobile device of claim 9, wherein the single emergency communication is a text message and wherein the probable location is sent in metadata of the text message.

16. The mobile device of claim 9, wherein the one or more hardware processors are further configured to perform operations comprising, after sending the single emergency communication, determining an update in the probable location of the mobile device, and sending the updated probable location of the mobile device.

17. An apparatus for providing an emergency text service, the apparatus comprising:
means for receiving an indication that an emergency text service has been started at the mobile device;
means for generating a user interface component for entry of a location by a user;
means for receiving, via the user interface component, location information entered by the user;
means for separately determining a probable location of the mobile device without user input;
generating a single emergency communication message including the location information entered by the user and the probable location of the mobile device; and
means for sending the single emergency communication message, in a single emergency communication from the mobile device, including both the location information entered by the user and the probable location of the mobile device.

18. The apparatus of claim 17, wherein the means for sending the single emergency communication include means for sending the single emergency communication to an emergency service system.

19. The apparatus of claim 17, wherein the means for sending the single emergency communication include, when the location information entered by the user corresponds to the probable location, means for sending in the single emergency communication an indication that the location information entered by the user is reliable.

20. The apparatus of claim 17, wherein the means for sending the single emergency communication include, when the location information entered by the user conflicts with the probable location, means for sending in the single emergency communication an indication that the location information entered by the user is unreliable.
